(19) United States
(12) Patent Application Publication
(10) Pub. No.: US 2012/0247354 A1
(43) Pub. Date: Oct. 4, 2012

(54) PERFECTING PRINTING UNIT AND TOWER

(76) Inventor: Louis M. Surbrook, Roy, WA (US)

(21) Appl. No.: 13/074,952

(22) Filed: Mar. 29, 2011

(51) Int. Cl. B41F 5/02

(52) U.S. Cl. 101/229; 101/483

(57) ABSTRACT

A continuous-blanket-contact perfecting printing tower that includes at least one perfecting printing unit that includes one-around circumference plate cylinders and a first blanket cylinder that is either one-around in circumference or two-around in circumference and also includes a second blanket cylinder that is either two-around in circumference or three-around in circumference. When the perfecting printing units are stacked in a continuous-blanket-contact tower configuration, the two-around circumference blanket cylinders and/or three-around circumference blanket cylinders allow more distance between the plate cylinders of adjacent perfecting printing units compared to continuous-blanket-contact designs that use only one-around circumference blanket cylinders. The additional distance between the plate cylinders of adjacent perfecting printing units created by the inclusion of two-around circumference blanket cylinders and/or three-around circumference blanket cylinders provides more space for more and/or larger rollers, oscillators, dampeners and/or print enhancement devices and the like, to be situated around the plate cylinders.

### BACKGROUND

Perfecting printing units can be used to print one or more colors on both sides of printing paper at the same time. A perfecting printing unit can print simultaneously on both sides of the paper by using the blanket cylinder of one side of the perfecting printing unit as the impression cylinder for the blanket cylinder of the other side of the perfecting printing unit.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to perfecting printing units (as shown in FIG. 1, FIG. 2, FIG. 3, and FIG. 4) and the use of these perfecting printing units in a continuous-blanket-contact configuration (as shown in FIG. 5, FIG. 6, FIG. 7, FIG. 8, FIG. 9 and FIG. 10). The perfecting printing unit shown in FIG. 1 and FIG. 2 includes a first blanket cylinder that is one-around in circumference and also a second blanket cylinder that is two-around in circumference. The perfecting printing unit shown in FIG. 1 and FIG. 2 also includes two one-around circumference plate cylinders, two inking systems and two dampening systems. The perfecting printing unit shown in FIG. 3 and FIG. 4 includes a first blanket cylinder that is two-around in circumference and a second blanket cylinder that is also two-around in circumference. The perfecting printing unit shown in FIG. 3 and FIG. 4 also includes two one-around circumference plate cylinders, two inking systems, and two dampening systems.

A continuous-blanket-contact configuration for a web offset press delivers the paper during the printing process in such a way that the paper is not released when travelling between perfecting printing units stacked in a tower configuration (the orientation of the tower could be either vertical or horizontal or otherwise). When stacked in a tower configuration, the second blanket cylinder of any perfecting printing unit is in contact (or nearly in contact) with the first blanket cylinder of any adjacent perfecting printing unit. The spacing between the stacked perfecting printing units is close enough such that paper travelling between adjacent perfecting printing units is not released when travelling from the blanket cylinder of one perfecting printing unit to the adjacent blanket cylinder of the adjacent stacked perfecting printing unit. Current continuous-blanket-contact printing towers consist of perfecting printing units using only one-around circumference blanket cylinders. The use of two-around circumference blanket cylinders (or even three-around circumference blanket cylinders) in a continuous-blanket-contact configuration provides many advantages over continuous-blanket-contact configuration designs using only one-around circumference blanket cylinders.

Differently configured perfecting printing units may be stacked. For example, when four perfecting printing units are stacked two of the perfecting printing units may include a first blanket cylinder that is one-around in circumference and a second blanket cylinder that is two-around in circumference. The other two of the perfecting printing units may include blanket cylinders that are both one-around in circumference.

### BRIEF DESCRIPTION OF THE DRAWINGS

FIG. 1 and FIG. 3 illustrate exemplary plate and blanket cylinder configurations for perfecting printing units capable of printing one color on one side of the paper and simultaneously printing one color on the other side of the paper;

FIG. 2 and FIG. 4 illustrate exemplary configurations for perfecting printing units containing plate and blanket cylinder configurations as illustrated in FIG. 1 and FIG. 3;

FIG. 5 and FIG. 7 illustrate exemplary plate and blanket cylinder configurations for continuous-blanket-contact printing towers for printing 4 colors on one side of the paper and simultaneously printing 4 colors on the other side of the paper;

FIG. 6 and FIG. 8 illustrate exemplary configurations showing examples of continuous-blanket-contact printing towers containing plate and blanket cylinder configurations as illustrated in FIG. 5 and FIG. 7; and

FIG. 9 and FIG. 10 illustrate exemplary plate and blanket cylinder configurations for continuous-blanket-contact printing towers for printing 4 colors on one side of the paper and simultaneously printing 4 colors on the other side of the paper.

### DETAILED DESCRIPTION

Embodiments of the present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art.

A perfecting printing unit can be used to print on both sides of printing paper at the same time. A perfecting printing unit can print simultaneously on both sides of the paper by using the blanket cylinder of one side of the perfecting printing unit as the impression cylinder for the blanket cylinder of the other side of the perfecting printing unit. Each perfecting printing unit typically contains two inking and dampening systems that supply ink to the desired places on the lithographic printing plates that are normally mounted on the opposing plate cylinders. The ink reservoirs and water reservoirs are separate for each side of the perfecting printing unit.

Four perfecting printing units may be used one after the other in a continuous-blanket-contact arrangement to provide four-color process printing using CMYK inks, for example. Additional perfecting printing units could be added for six-color printing, etc. Other numbers of perfecting printing units may be used for other configurations.

A continuous-blanket-contact printing tower typically combines multiple perfecting printing units in such a way that the paper is not released when passing from one perfecting printing unit to another. Each blanket cylinder of one perfecting unit is in contact (or nearly in contact) with the adjacent blanket cylinder of its adjacent perfecting printing units, the spacing being close enough between adjacent blanket cylinders to not effect release of the paper. The printing of various colors in a continuous-blanket-contact design helps to reduce color registration errors, including color registration errors caused by wetting of the paper or paper tension changes (and subsequent stretching) of the paper as typically happens when paper travels released from one perfecting printing unit to another perfecting printing unit. If the paper is allowed to travel released between perfecting units (due to the blanket cylinders between adjacent perfecting printing units being spaced too far apart—as is the case with all non-continuous-blanket-contact designs), then the tension on the paper and/or the wetting of the paper causes the paper (and thus the various color images) to mis-register, stretch, or distort and thus cause misplacement and/or distortion of the individual printed images.

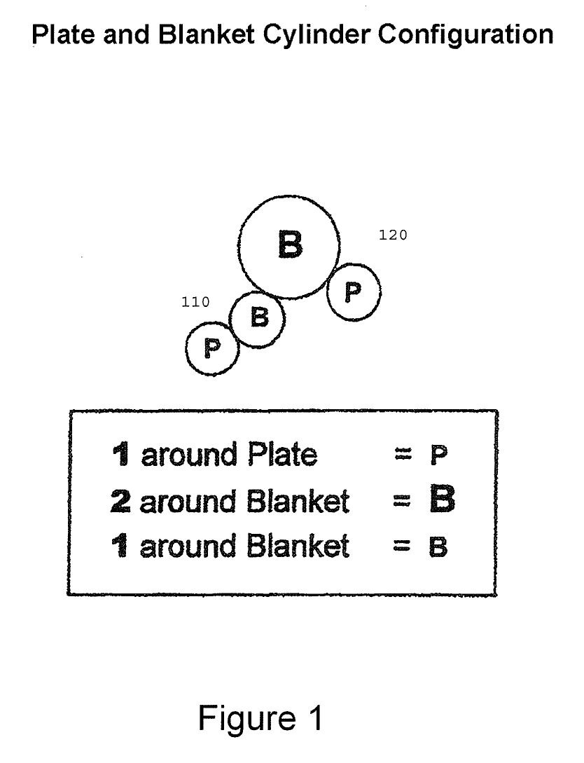

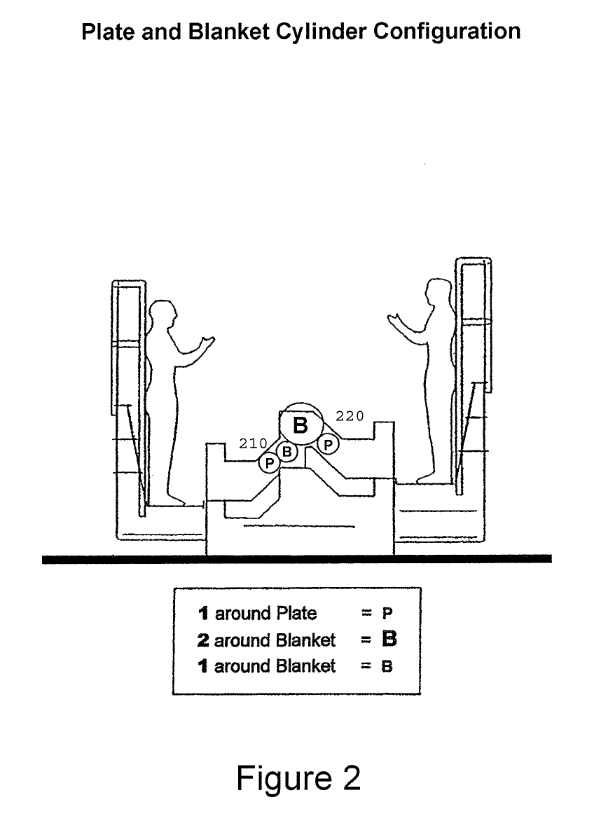

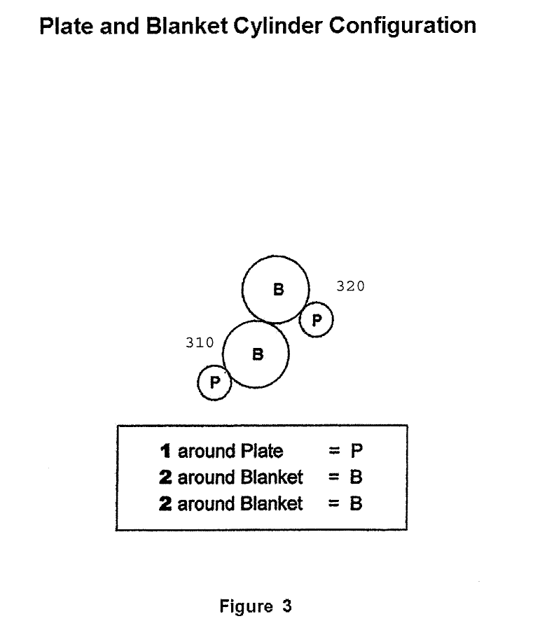

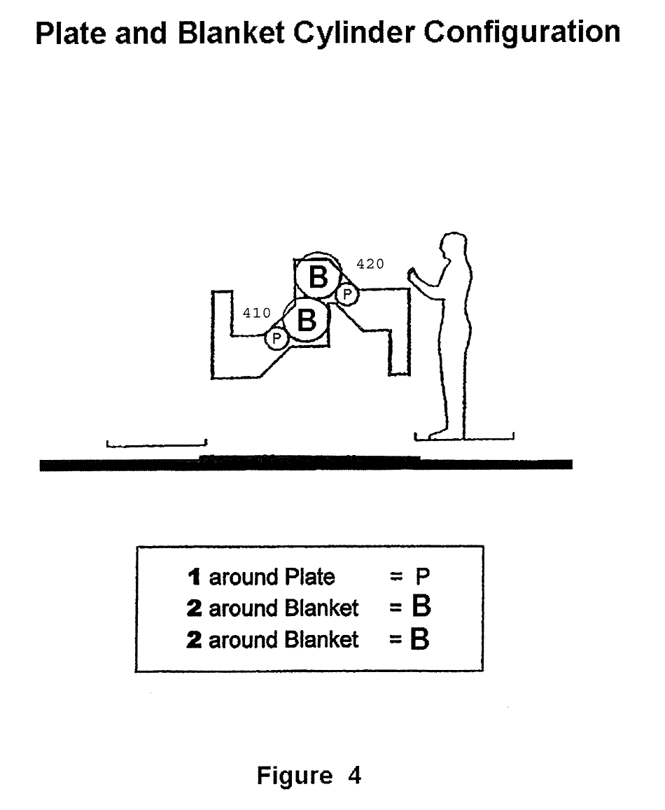

Plate and blanket cylinder configurations of perfecting printing units that use “one-around” circumference plate cylinders, and use at least one “two-around” circumference blanket cylinder, are illustrated in FIG. 1, FIG. 2, FIG. 3, and FIG. 4. A one-around circumference plate cylinder is a plate cylinder that is capable of carrying one or more lithographic printing plates and having a circumference that is sufficient to transmit an image equal in size to the image area of a one-around circumference blanket cylinder and half the image area of a two-around circumference blanket cylinder.

In FIGS. 1 and 2, the first half (110, 210) of each perfecting printing unit contains a blanket cylinder that is “one-around” in circumference. The one-around circumference blanket cylinder is typically nearly equal in circumference to the one-around circumference plate cylinder. (Plate cylinders as well as blanket cylinders can have larger integer circumference ratios depending on printing requirements.) In FIGS. 1 and 2, the second half (120, 220) of each perfecting printing unit contains a blanket cylinder that is “two-around” in circumference (i.e. has twice the circumference of the blanket cylinder in the first half of the perfecting printing unit). The one-around circumference blanket cylinder and the two-around circumference blanket cylinder serve as each other's impression cylinder and each of those two blanket cylinders act as the image transfer cylinder for its corresponding one-around circumference plate cylinder (both blanket cylinders act as the image transfer cylinder for a one-around circumference plate cylinder). As in a conventional perfecting printing unit, one blanket cylinder typically serves as the impression cylinder for the opposing blanket cylinder.

In FIGS. 3 and 4, the first half (310, 410) of each perfecting printing unit contains a blanket cylinder that is “two-around” in circumference. The two-around circumference blanket cylinder is typically nearly twice the circumference of the one-around circumference plate cylinder. (Plate cylinders as well as blanket cylinders can have larger integer circumference ratios depending on printing requirements.) In FIGS. 3 and 4, the second half (320, 420) of each perfecting printing unit contains a blanket cylinder that is also “two-around” in circumference. The first two-around circumference blanket cylinder and the second two-around circumference blanket cylinder serve as each other's impression cylinder and each of those two blanket cylinders act as the image transfer cylinder for its corresponding one-around circumference plate cylinder (both blanket cylinders act as the image transfer cylinder for a one-around circumference plate cylinder). As in a conventional perfecting printing unit, one blanket cylinder typically serves as the impression cylinder for the opposing blanket cylinder.

When stacked one on top of the other, the perfecting printing units form a continuous-blanket-contact design for a perfecting printing tower capable of printing using multiple colors of inks (the orientation of the tower could also be horizontal, in which case the perfecting printing units would be stacked next to each other horizontally to form a continuous-blanket-contact design—and other orientations could be used as well).

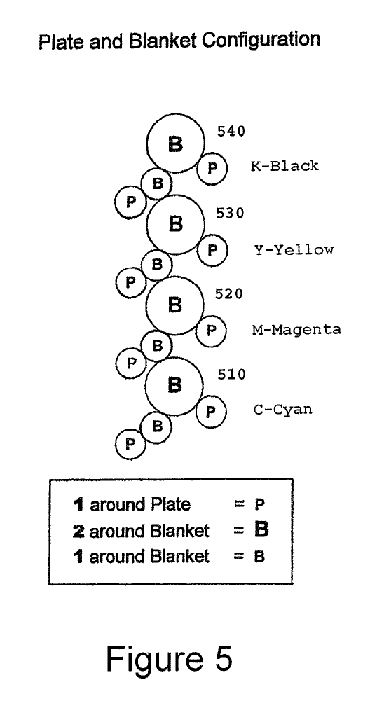

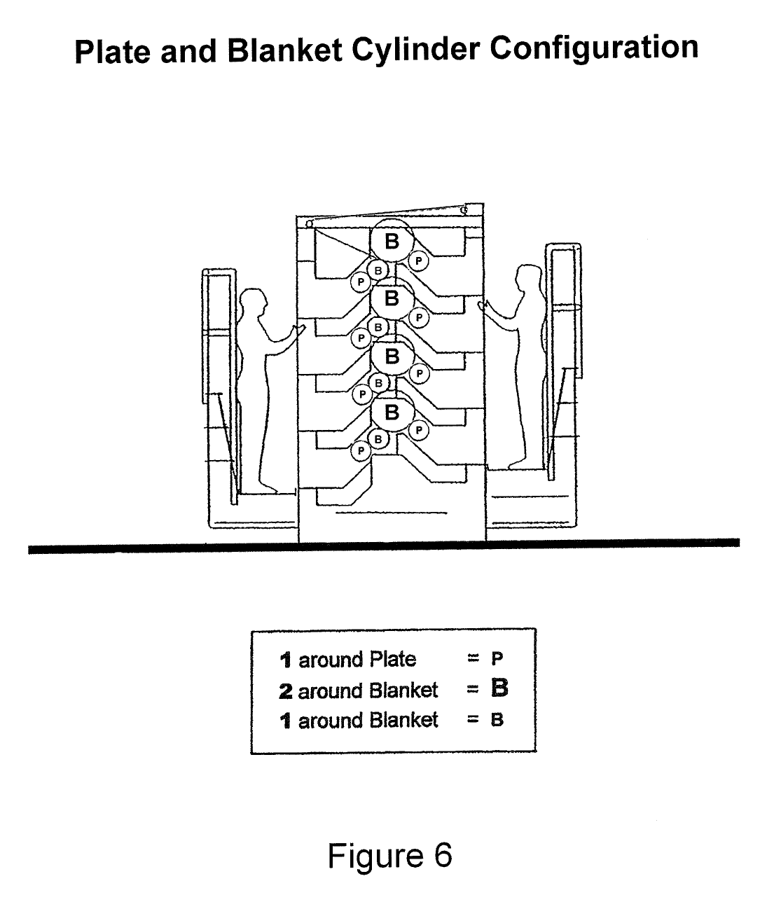

In FIG. 5 and FIG. 6, a typical blanket cylinder configuration is shown with every second blanket cylinder (510, 520, 530, and 540) being two-around in circumference rather than one-around in circumference as in the opposing side. Stacking of perfecting printing units, each having a two-around circumference blanket cylinder along with a one-around circumference blanket cylinder (as shown in FIG. 5 and FIG. 6) allows more space between adjacent stacked perfecting printing unit's plate cylinders than current continuous-blanket-contact designs that use only one-around circumference blanket cylinders. The additional space between adjacent perfecting printing unit's plate cylinders is obtained while maintaining the advantage of the continuous-blanket-contact configuration and maintaining the advantage of a low profile for the printing tower.

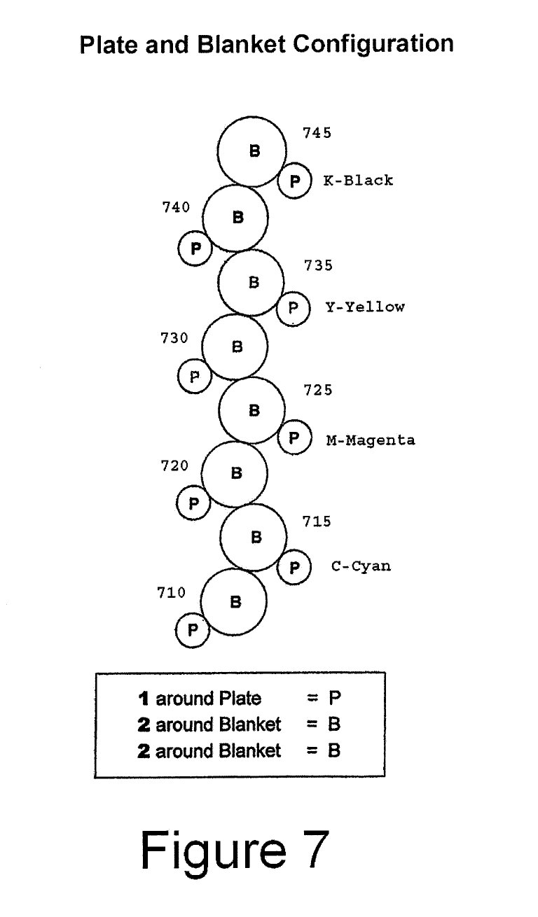

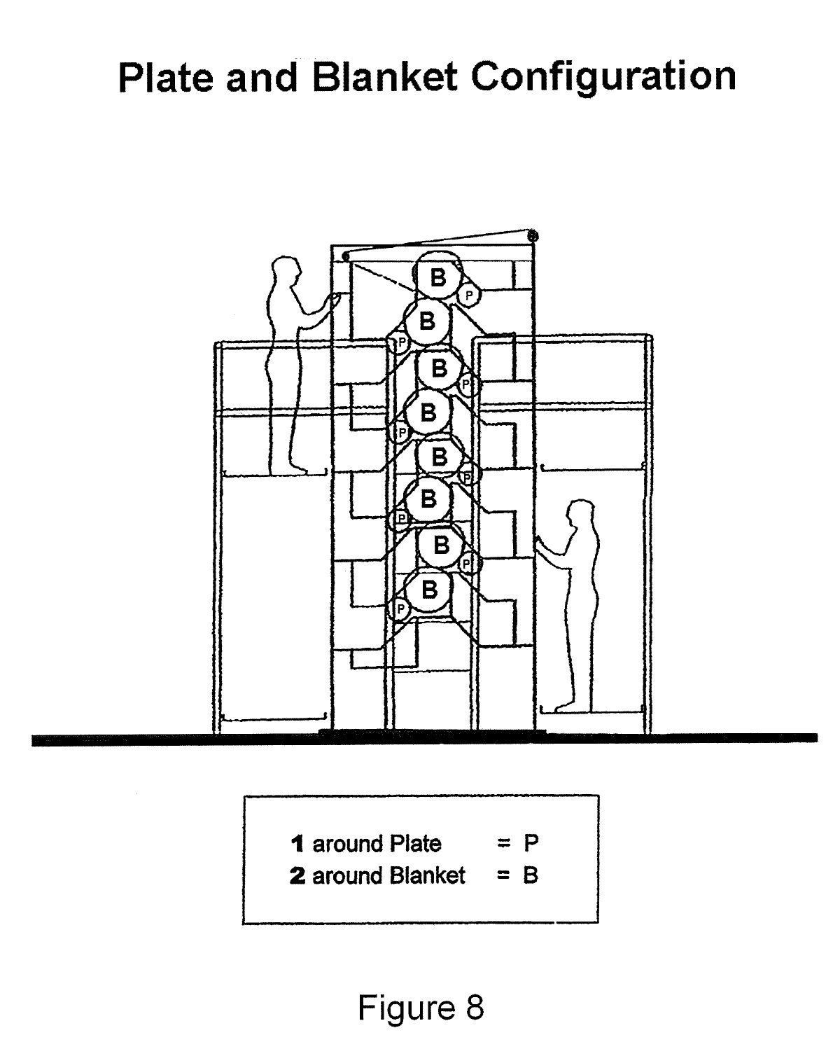

In FIG. 7 and FIG. 8, a typical blanket cylinder configuration is shown wherein every blanket cylinder (710, 715, 720, 725, 730, 735, 740 and 745) is two-around in circumference rather than one-around in circumference. Stacking of perfecting printing units, each having a two-around circumference blanket cylinder along with a second two-around circumference blanket cylinder (as shown in FIG. 7 and FIG. 8) allows more space between adjacent perfecting printing unit's plate cylinders than current continuous-blanket-contact designs that use only one-around circumference blanket cylinders. Additional space between adjacent perfecting printing unit's plate cylinders is obtained while maintaining the advantage of the continuous-blanket-contact configuration and maintaining the advantage of a low profile for the printing tower.

The two-around circumference blanket cylinders (as shown in FIG. 5, FIG. 6, FIG. 7, and FIG. 8), for example, allow for more and/or larger rollers, oscillators, dampeners and/or print enhancement devices and the like, to be situated around the plate cylinders due to the increased space provided by using the double circumference blanket cylinders (triple circumference blanket cylinders could also be used). The increased space also allows for less printing challenges caused by heat buildup. Additionally, larger gears and other components, or alternative designs that require more space, can be used to increase the durability and effectiveness of the printing unit.

Accordingly, when the perfecting printing units are stacked in a tower configuration, the space around the plate cylinders is increased without increasing clearances between the last blanket cylinder of each perfecting printing unit and the first blanket cylinder of the next perfecting printing unit in the tower configuration (i.e. still allowing the paper to not be released when passing from one perfecting printing unit to another). As discussed above, paper that is released and travelling unsupported between perfecting printing units (rather than being passed into immediate contact, or almost immediate contact, with the adjacent perfecting printing unit's blanket cylinder—i.e. the paper not being released) can increase registration problems and allow paper-stretch to occur.

FIG. 6 shows a continuous-blanket-contact printing tower illustrated as having a two-around blanket cylinder and a one-around blanket cylinder in each perfecting printing unit. FIG. 8 show a continuous-blanket-contact printing tower illustrated as having a two-around blanket cylinder along with a second two-around blanket cylinder in each perfecting printing unit. These examples demonstrate that the invention provides greater space between the plate cylinders of adjacent perfecting printing units than current continuous-blanket-contact designs that use only one-around circumference blanket cylinders while maintaining the advantage of a continuous-blanket-contact configuration and maintaining the advantage of a low profile for the printing tower (although the height is increased compared to designs using only one-around circumference blanket cylinders due to the size difference of the two-around blanket cylinders).

Accordingly, when the perfecting printing units are stacked in a tower configuration, the space around the plate cylinders is increased without increasing clearances between the last blanket cylinder of each perfecting printing unit and the first blanket cylinder of the next perfecting printing unit in the tower configuration (i.e. still allowing the paper to not be released when passing from one perfecting printing unit to another). As discussed above, paper that is released and travelling unsupported between perfecting printing units (rather than being passed into immediate contact, or almost immediate contact, with the adjacent perfecting printing unit's blanket cylinder—i.e. the paper not being released) can increase registration problems.

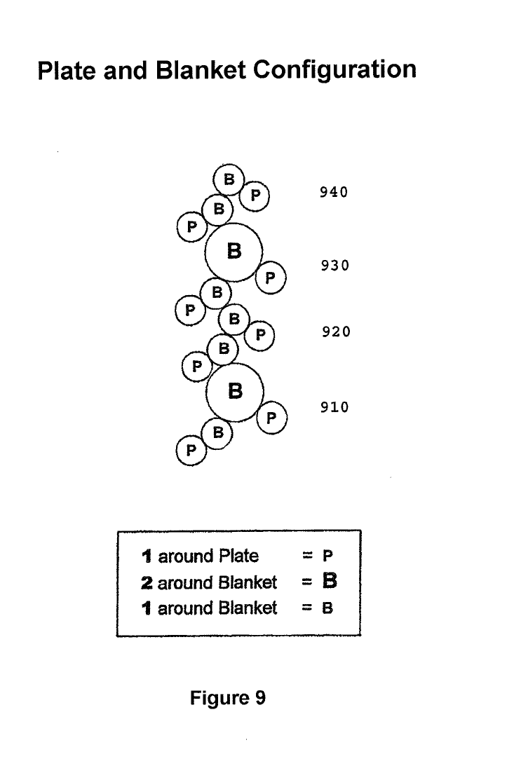

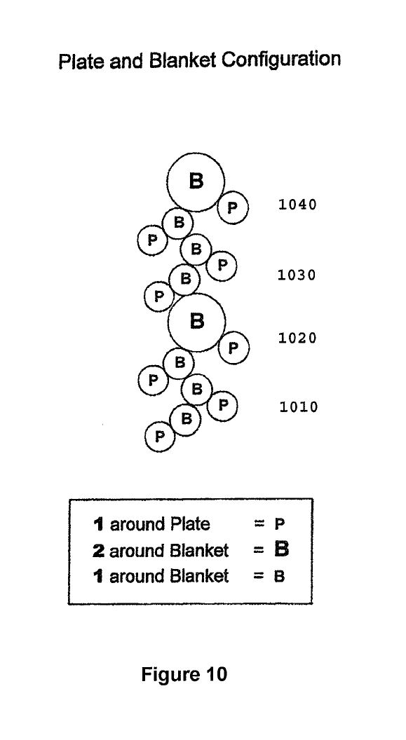

In FIG. 9 and FIG. 10, stacked perfecting printing units are shown in a continuous-blanket-contact tower configuration. FIG. 9 illustrates a first ordering of the stacked perfecting printing units and FIG. 10 illustrates a second ordering of the stacked perfecting printing units. FIG. 9 shows a first perfecting printing unit 910 and a third perfecting printing unit 930, both of which include a first blanket cylinder that is one-around in circumference and a second blanket cylinder that is two-around in circumference. Alternatively, the second blanket cylinder may be three-around in circumference in first perfecting printing unit 910 and the third perfecting printing unit 930. FIG. 9 shows the second perfecting printing unit 920 and the fourth perfecting printing unit 940 each having two blanket cylinders and two plate cylinders that are one-around in circumference.

FIG. 10 shows a first perfecting printing unit 1010 and a third perfecting printing unit 1030 each having two blanket cylinders and two plate cylinders that are one-around in circumference. The second perfecting printing unit 1020 and fourth perfecting printing unit 1040 each include a first blanket cylinder that is one-around in circumference and a second blanket cylinder that is two-around in circumference. Alternatively, the second blanket cylinder may be three-around in circumference in the second perfecting printing unit 1020 and the fourth perfecting printing unit 1040.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A perfecting printing unit comprising:
a first blanket cylinder that is at least one-around in circumference;
a second blanket cylinder that is at least two-around in circumference, wherein the first blanket cylinder and the second blanket cylinder serve as impression cylinders for each other;
plate cylinders that are one-around in circumference;
two inking systems; and
two dampening systems.

2. The perfecting printing unit of claim 1, wherein the first blanket cylinder is two-around in circumference and the second blanket cylinder is two-around in circumference.

3. The perfecting printing unit of claim 1, wherein the first blanket cylinder is one-around in circumference and the second blanket cylinder is three-around in circumference

4. The perfecting printing unit of claim 1, wherein the first blanket cylinder is one-around in circumference and the second blanket cylinder is two-around in circumference

5. A perfecting printing tower comprising multiple stacked perfecting printing units, comprising:
a first perfecting printing unit, comprising:
a first blanket cylinder that is at least one-around in circumference;
a second blanket cylinder that is at least one-around in circumference, wherein the first blanket cylinder and the second blanket cylinder serve as impression cylinders for each other, and wherein the first blanket cylinder contacts (or nearly contacts) the second blanket cylinder of any adjacent perfecting printing unit stacked prior to the perfecting printing unit; and wherein the second blanket cylinder contacts (or nearly contacts) the first blanket cylinder of any adjacent perfecting printing unit stacked subsequent to the perfecting printing unit;
plate cylinders that are one-around in circumference;
two inking systems; and
two dampening systems;
and
a second perfecting printing unit, comprising:
a first blanket cylinder that is at least one-around in circumference;
a second blanket cylinder that is at least two-around in circumference, wherein the first blanket cylinder and the second blanket cylinder serve as impression cylinders for each other, and wherein the first blanket cylinder contacts (or nearly contacts) the second blanket cylinder of any adjacent perfecting printing unit stacked prior to the perfecting printing unit; and wherein the second blanket cylinder contacts (or nearly contacts) the first blanket cylinder of any adjacent perfecting printing unit stacked subsequent to the perfecting printing unit;
plate cylinders that are one-around in circumference;
two inking systems; and
two dampening systems.

6. The perfecting printing tower of claim 5, wherein the first blanket cylinder is two-around in circumference and the second blanket cylinder is two-around in circumference for each of the perfecting printing units.

7. The perfecting printing tower of claim 5, wherein the first blanket cylinder is one-around in circumference and the second blanket cylinder is three-around in circumference for each of the perfecting printing units.

8. The perfecting printing tower of claim 5, wherein the first blanket cylinder is one-around in circumference and the second blanket cylinder is two-around in circumference for each of the perfecting printing units.

9. The perfecting printing tower of claim 5, wherein the first blanket cylinder and the second blanket cylinder of the first perfecting printing unit is one-around in circumference and the first blanket cylinder of the second perfecting printing unit is one-around in circumference and the second blanket cylinder of the second perfecting printing unit is either two-around in circumference or three-around in circumference.

10. The perfecting printing tower of claim 5, wherein the first blanket cylinder of the first perfecting printing unit is one-around in circumference and the second blanket cylinder of the first perfecting printing unit is either two-around in circumference or three-around in circumference and the first blanket cylinder and the second blanket cylinder of the second perfecting printing unit is one-around in circumference.

11. A method for printing using multiple stacked perfecting printing units in a continuous-blanket-contact perfecting printing tower configuration, comprising:
receiving paper to print;
feeding the paper to a first perfecting printing unit; and
feeding the paper from the first perfecting printing unit to the next perfecting printing unit and then to any further subsequent perfecting printing units in the tower while providing for the paper to not be released when passing from one perfecting printing unit to another, wherein one of the perfecting printing units includes: plate cylinders that are one-around in circumference; a first blanket cylinder that is at least one-around in circumference; a second blanket cylinder that is at least one-around in circumference; two inking systems; and two dampening systems, and wherein another of the perfecting printing unit includes: plate cylinders that are one-around in circumference; a first blanket cylinder that is at least one-around in circumference; a second blanket cylinder that is at least two-around in circumference; two inking systems; and two dampening systems.

12. The method of claim 11, wherein the first blanket cylinder is two-around in circumference and the second blanket cylinder is two-around in circumference for each of the perfecting printing units.

13. The method of claim 11, wherein the first blanket cylinder is one-around in circumference and the second blanket cylinder is three-around in circumference for each of the perfecting printing units.

14. The method of claim 11, wherein the first blanket cylinder is one-around in circumference and the second blanket cylinder is two-around in circumference for each of the perfecting printing units.

15. The method of claim 11, wherein the first blanket cylinder and the second blanket cylinder of the first perfecting printing unit is one-around in circumference and the first blanket cylinder of the second perfecting printing unit is one-around in circumference and the second blanket cylinder of the second perfecting printing unit is either two-around in circumference or three-around in circumference.

16. The method of claim 11, wherein the first blanket cylinder for the first perfecting printing unit is one-around in circumference and the second blanket cylinder of the first perfecting printing unit is either two-around in circumference or three-around in circumference and the first blanket cylinder of the second perfecting printing unit is one-around in circumference and the second blanket cylinder of the second perfecting printing unit is one-around in circumference.
